(19) United States
(12) Patent Application Publication
(10) Pub. No.: US 2009/0101852 A1
(43) Pub. Date: Apr. 23, 2009

(54) Passage switching valve

(75) Inventors: Yukihiro Harada, Kariya-shi (JP); Yasuhiro Tsuzuki, Chita-gun (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/285,100

(22) Filed: Sep. 29, 2008

(30) Foreign Application Priority Data
Oct. 23, 2007 (JP) 2007-274650

(51) Int. Cl. F16K 31/128

(52) U.S. Cl. 251/61

(57) ABSTRACT

A passage switching valve includes a lower actuator and an upper actuator. the lower actuator includes a case, a diaphragm, an operating rod, and a spring. A lower end of the operating rod is connected to a valve element. The upper actuator includes a case, a diaphragm, an operating rod, and a spring. An upper end of the lower operating rod is abuttable on a lower end of the upper operating rod. The upper pressure chamber and the lower negative pressure chamber are communicated with each other. Each of the negative pressure chambers of the actuators is to be supplied with negative pressure. Each of the operating rods is held against vibration by a bush. The lower spring is set to be greater in urging force than the upper spring.

### CROSS-REFERENCE TO RELATED APPLICATIONS

This application is based upon and claims the benefit of priority from each of the prior Japanese Patent Application No. 2007-274650 filed on Oct. 23, 2007, the entire contents of which are incorporated herein by reference.

### BACKGROUND OF THE INVENTION

1. Field of the Invention

The present invention relates to a passage switching valve to be used for switching a passage of a fluid and more particularly to a flow passage switching valve arranged to actuate a valve element by a diaphragm actuator.

2. Description of Related Art

Heretofore, an EGR (exhaust gas recirculation) system for reducing NOx in exhaust gas has been adopted for engines such as a diesel engine. In this EGR system, if hot exhaust gas is directly circulated back to an intake side, such hot expanded exhaust gas is supplied to an intake manifold, resulting in an increase in the rate of exhaust gas in each cylinder. Thus, some problems occur that may decrease the amount of air in each cylinder, lower combustion efficiency, and deteriorate components of exhaust gas such as NOx.

Some EGR systems therefore are provided with an EGR cooler in part of an EGR passage for cooling exhaust gas (EGR gas) by heat exchange with cooling water. This EGR cooler is arranged to cool hot exhaust gas (EGR gas) by the EGR cooler and then return the gas to the intake manifold. Herein, in the case where the temperature of cooling water is low during engine start or during a cold period, the EGR system with EGR cooler may excessively cool EGR gas, thus lowering combustion efficiency and deteriorating components of exhaust gas in each cylinder. During the engine start or the cold period in which the temperature of cooling water is lower than normal, therefore, the EGR system is operated to cause EGR gas to flow in a bypass passage provided to detour around the EGR cooler so that the EGR gas not cooled by the EGR cooler is recirculated back to the intake manifold. Specifically, the use of the EGR cooler and the nonuse thereof are selectively switched.

Herein, a passage switching valve is used for switching between the use of the EGR cooler and the nonuse thereof. As the valve of this type, a valve disclosed in JP2005-282520A for selectively opening and closing a valve element by use of a diaphragm actuator has come into practical use.

However, the passage switching valve disclosed in JP '520A could only select two states, i.e., a fully opened state and a fully close state, and could not select an intermediate degree of opening. Therefore, selection could only be made between the case of cooling and the case of noncooling EGR gas by the EGR cooler. Thus, the valve could only provide a low degree of freedom of controlling EGR gas temperature.

Herein, it is conceivable to steplessly adjust the opening degree of the valve element by use of an electric motor such as a step motor in order to increase the degree of freedom of controlling the EGR gas temperature. In this case, however, it is required not only an expensive electric motor but also attachments such as a controller for controlling the electric motor and a sensor for detecting the opening degree of the valve element. Consequently, an entire apparatus would be expensive and complicated.

In this respect, the passage switching valve configured to open and close the valve element by use of the diaphragm actuator is relatively inexpensive and more simple in structure. This diaphragm actuator, however, tends to be sensitive to vibration due to its structure. This would cause a problem with vibration resistance in the case where the valve is mounted in a diesel engine which causes larger vibrations than a gasoline engine.

### BRIEF SUMMARY OF THE INVENTION

The present invention has been made in view of the above circumstances and has a first object to provide a passage switching valve capable of adjusting the opening degree of a valve element in at least three stages by use of a diaphragm actuator.

A second object of the present invention is providing a passage switching valve superior to vibration resistance in addition to the first object.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a passage switching valve comprising: a valve element to be operated to switch between passages; and a diaphragm actuator for operating the valve element, wherein the actuator includes a first actuator and a second actuator placed one on top of the first actuator, the first actuator including: a first case; a first diaphragm dividing internal space of the first case to form a first negative pressure chamber; a first operating rod fixed at an upper portion to the first diaphragm; and a first spring interposed between the first case and the first diaphragm in the first negative pressure chamber, the first operating rod being placed to extend downward from the first case and be connected to the valve element to operate the valve element, the second actuator including: a second case; a second diaphragm dividing internal space of the second case to form an upper second negative pressure chamber and a lower second pressure chamber; a second operating rod fixed at an upper portion to the second diaphragm; and a second spring interposed between the second case and the second diaphragm in the second negative pressure chamber, the second operating rod being placed to extend through the second case and the first case into the first negative pressure chamber so that an upper end of the first operating rod is abuttable on a lower end of the second operating rod, and the second pressure chamber and the first negative pressure chamber being communicated with each other.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a schematic configuration view of an EGR system with EGR cooler in a first embodiment;

FIG. 2 is a plan view of a bypass valve in the first embodiment;

FIG. 3 is a bottom view of the bypass valve in the first embodiment;

FIG. 4 is a sectional view of a two-stage actuator in the first embodiment, taken along a line A-A in FIG. 2;

FIG. 5 is a sectional view of a passage block in the first embodiment, taken along a line B-B in FIG. 3;

FIG. 6 is a sectional view of the passage block in the first embodiment, taken along a line C-C in FIG. 3;

FIG. 7 is a sectional view of the two-stage actuator in the first embodiment, showing a state changed from a state shown in FIG. 4;

FIG. 8 is a sectional view of the passage block in the first embodiment, showing a state changed from a state shown in FIG. 5;

FIG. 9 is a sectional view of the passage block in the first embodiment, showing a state changed from a state shown in FIG. 6;

FIG. 10 is a sectional view of the two-stage actuator in the first embodiment, showing a state changed from a state shown in FIG. 7;

FIG. 11 is a sectional view of the passage block in the first embodiment, showing a state changed from a state shown in FIG. 8;

FIG. 12 is a sectional view of the passage block in the first embodiment, showing a state changed from a state shown in FIG. 9;

FIG. 13 is a partly sectional, bottom view of a bypass valve in a second embodiment;

FIG. 14 is a sectional view of a passage block in the second embodiment, taken along a line D-D in FIG. 13;

FIG. 15 is a sectional view of the passage block in the second embodiment, showing a state changed from a state shown in FIG. 14;

FIG. 16 is a sectional view of the passage block in the second embodiment, showing a state changed from a state shown in FIG. 15; and

FIG. 17 is a sectional view of a three-stage actuator in a third embodiment.

### DETAILED DESCRIPTION OF THE PREFERRED EMBODIMENTS

### First Embodiment

A detailed description of a first preferred embodiment of a passage switching valve embodying the present invention will now be given referring to the accompanying drawings. In this embodiment, the passage switching valve of the invention will be explained as an EGR cooler bypass valve in an EGR system with EGR cooler.

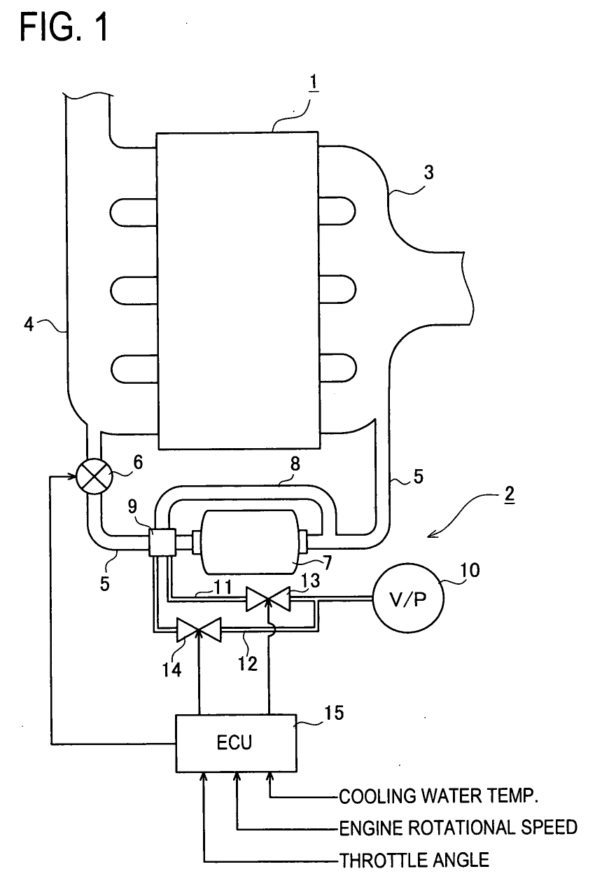

FIG. 1 is a schematic configuration view of an EGR system 2 with EGR cooler mounted in a diesel engine 1. This EGR system 2 is arranged to recirculate part of exhaust gas discharged from the engine 1 to an exhaust manifold 3, back to an intake manifold 4 for use as EGR gas. This EGR system 2 includes an EGR passage 5 in which EGR gas flows, an EGR valve 6 for regulating a flow rate of EGR gas, an EGR cooler 7 for cooling EGR gas, an EGR cooler bypass passage 8 provided in the EGR passage 5 to detour the EGR cooler 7, and an EGR cooler bypass valve (hereinafter, referred to as a “bypass valve”) 9 placed in a junction of the bypass passage 8 and the EGR passage 5. In this embodiment, the bypass valve 9 is operated to switch the flow of EGR gas among a state of allowing EGR gas to flow in only the EGR cooler 7, a state of allowing EGR gas to flow in only the bypass passage 8, and a state of allowing EGR gas to flow in both the EGR cooler 7 and the bypass passage 8.

The EGR cooler 7 is connected to a pipe (not shown) for cooling water circulation to circulate cooling water of the engine 1. The EGR cooler 7 is configured to exchange heat between hot EGR gas and cooling water. The bypass valve 9 is activated by a diaphragm actuator. This bypass valve 9 will be supplied with negative pressure from a negative pressure pump 10 through a first negative pressure pipe 11 and a second negative pressure pipe 12. At some midpoints of those negative pressure pipes 11 and 12, first and second vacuum switching valve (VSV) 13 and 14 are placed respectively. The VSVs 13 and 14 are selectively opened and closed to control supply of negative pressure to the diaphragm actuator of the bypass valve 9, thereby activating the bypass valve 9. The EGR valve 6 and each of the VSVs 13 and 14 are controlled by an electronic control unit (ECU) 15 according to an engine operating condition. The ECU 15 is arranged to receive various parameters on the engine operating condition such as cooling water temperature, engine rotational speed, and throttle opening of the engine 1 which are detected by various sensors (not shown), and determine the engine operating condition from those parameters to selectively open and close the VSVs 13 and 14 as appropriate. Herein, as an opening/closing mode of each of the VSVs 13 and 14, three modes have been set in advance; that is, an initial mode where the VSVs 13 and 14 are both closed, a first operating mode where the first VSV 13 is opened while the second VSV 14 is closed, and a second operating mode where the VSVs 13 and 14 are both opened.

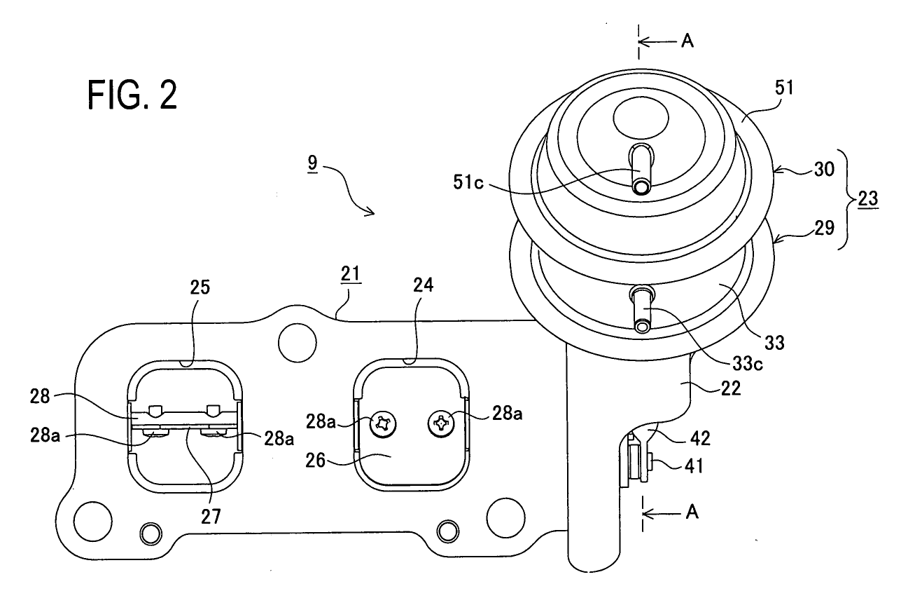

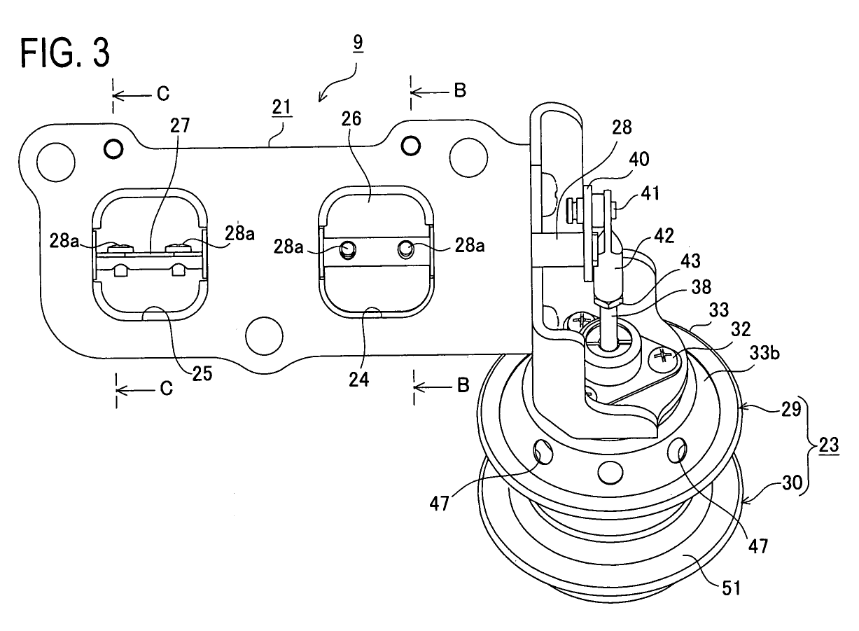

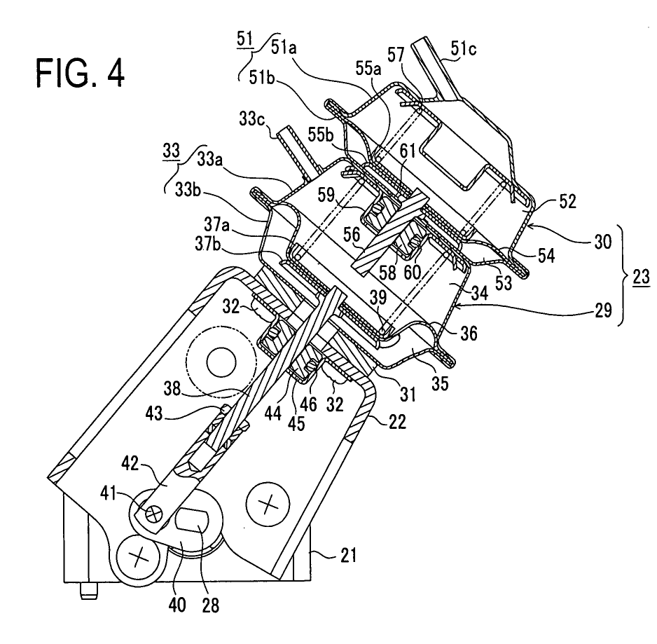

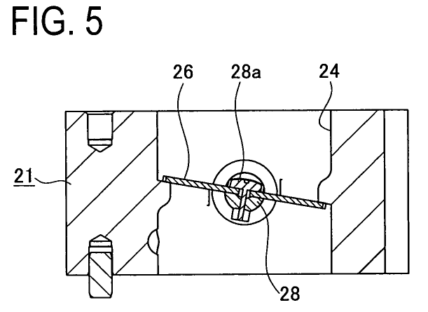

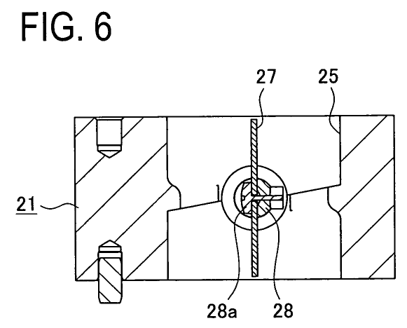

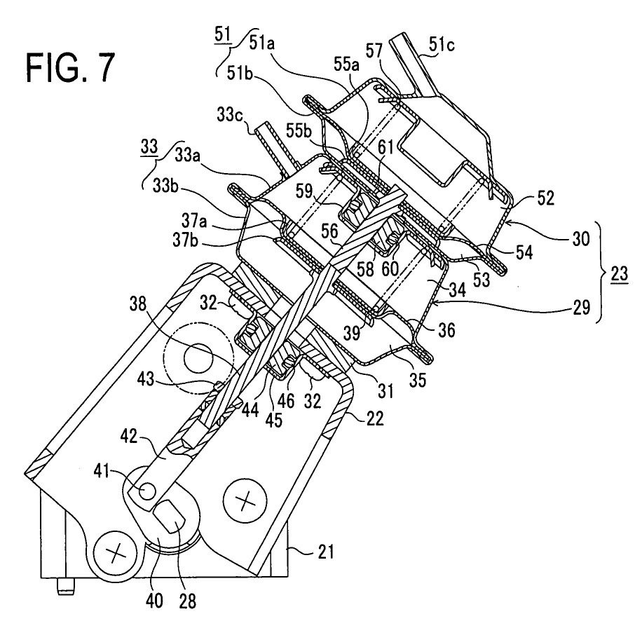

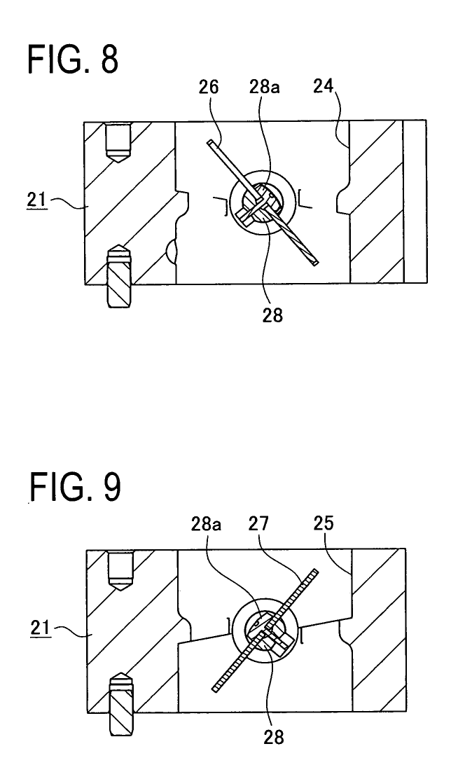

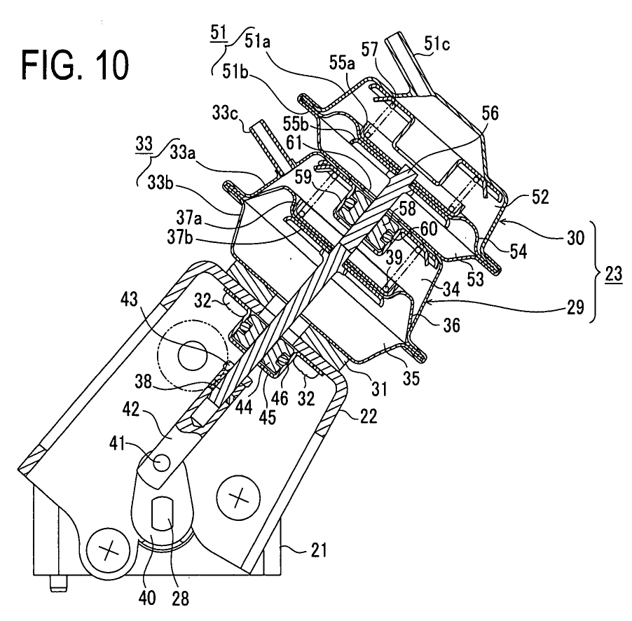

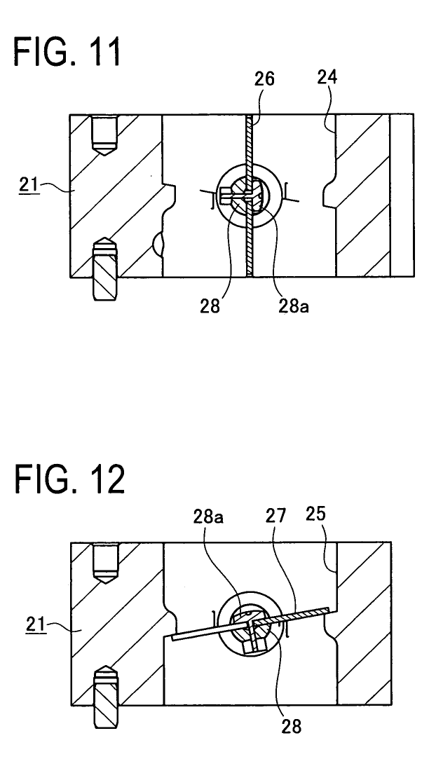

The details of the bypass valve 9 will be explained below. FIG. 2 is a plan view of the bypass valve 9. FIG. 3 is a bottom view of the bypass valve 9. FIG. 4 is a sectional view of a two-stage actuator taken along a line A-A in FIG. 2. FIG. 5 is a sectional view of a passage block taken along a line B-B in FIG. 3. FIG. 6 is a sectional view of the passage block taken along a line C-C in FIG. 3. FIG. 7 is a sectional view of the two-stage actuator in a state changed from a state shown in FIG. 4. FIG. 8 is a sectional view of the passage block in a state changed from a state shown in FIG. 5. FIG. 9 is a sectional view of the passage block in a state changed from a state shown in FIG. 6. FIG. 10 is a sectional view of the two-stage actuator in a state changed from a state shown in FIG. 7. FIG. 11 is a sectional view of the passage block in a state changed from a state shown in FIG. 8. FIG. 12 is a sectional view of the passage block in a state changed from a state shown in FIG. 9.

As shown in FIGS. 2 and 3, the bypass valve 9 includes a passage block 21 connected to the EGR cooler 7 and the bypass passage 8 respectively, and a two-stage actuator 23 fixed to one side surface of the passage block 21 by means of a bracket 22. The passage block 21 is formed with a bypass passage 24 which communicates with the bypass passage 8 and a main passage 25 which communicates with the EGR cooler 7 so that the passages 24 and 25 are arranged in parallel. In the bypass passage 24, a first butterfly valve element 26 is placed. In the main passage 25, similarly, a second butterfly valve element 27 is placed. Both valve elements 26 and 27 are fixed onto a common valve shaft 28 respectively with screws 28a. This valve shaft 28 is placed extending across both the passages 24 and 25 and rotatably supported in the passage block 21. One end of the valve shaft 28 passes through the passage block 21 and the bracket 22 to protrude outside. FIGS. 2 and 3 show an initial state where no negative pressure is supplied to the two-stage actuator 23. In this initial state, the first valve element 26 is fully closed and the second valve element 27 is fully opened.

As shown in FIGS. 2 to 4, the two-stage actuator 23 include a first diaphragm actuator 29 and a second diaphragm actuator 30 which are placed one on the other. The first actuator 29 located in a lower side is fixed to a top of the bracket 22 with screws 32, with a plate 31 being interposed therebetween. The first actuator 29 includes a first case 33 constituted of upper and lower covers 33a and 33b which are assembled by caulking, a first diaphragm 36 which divides the internal space of the first case 33 into an upper, first negative pressure chamber 34 and a lower, first pressure chamber 35. The first actuator 29 further includes shells 37a and 37b between which the center portion of the first diaphragm 36 is sandwiched, a first operating rod 38 whose upper end is fixed to the center of the shells 37a and 37b, and a first spring 39 interposed between the upper cover 33a and the shell 37a in the first negative pressure chamber 34. The first operating rod 38 extends downward through the bracket 22. One end of the valve shaft 28 protruding out from the side surface of the bracket 22 is connected to a lever 40. A distal end of this lever 40 rotatably supports a link rod 42 through a pin 41. A distal end of the link rod 42 is connected to a lower end of the first operating rod 38 with a nut 43. The lower end of the first operating rod 38 and the distal end of the link rod 42 are connected with threads of a male screw and a female screw so as to be adjustable in position. The first operating rod 38 is slidably supported by a first bush 44 provided on an inner wall of the top of the bracket 22. This bush 44 is fixed by a retainer 45 to the bracket 22 with screws 32. An O-ring 46 is interposed between the first bush 44 and the retainer 45. The first bush 44 serves to restrain vibration of the first operating rod 38 in a radial direction. As shown in FIG. 3, the lower cover 33b of the first actuator 29 is formed with air holes 47 through which the first pressure chamber 35 is communicated to atmosphere. As shown in FIGS. 2 and 4, the upper cover 33a of the first actuator 29 is formed with a first tube 33c protruding to be connected to one end of the first negative pressure pipe 11.

The second actuator 30 placed in an upper side is fixed to the top of the upper cover 33a of the first actuator 29 by welding or the like. The second actuator 30 includes a second case 51 constituted of upper and lower covers 51a and 51b which are assembled by caulking, a second diaphragm 54 which divides the internal space of the second case 51 into an upper, second negative pressure chamber 52 and a lower, second pressure chamber 53. The second actuator 30 further includes shells 55a and 55b between which the center portion of the second diaphragm 54 is sandwiched, a second operating rod 56 whose upper end is fixed to the center of the shells 55a and 55b, and a second spring 57 interposed between the upper cover 51a and the shell 55a in the second negative pressure chamber 52. The second operating rod 56 extends downward through the lower cover 51b of the second case 51 and the upper cover 33a of the first case 33 so that a lower end of the rod 56 is located in the first negative pressure chamber 34. The upper end of the first operating rod 38 is abuttable on the lower end of the second operating rod 56. The second operating rod 56 is slidably supported by a second bush 58 provided on an inner wall of the top of the upper cover 33a of the first actuator 29. This bush 58 is fixed by a retainer 59 to the upper cover 33a. An O-ring 60 is interposed between the second bush 58 and the retainer 59. The second bush 58 serves to restrain vibration of the second operating rod 56 in a radial direction. As shown in FIG. 4, the lower cover 51b of the second actuator 30 and the upper cover 33a of the first actuator 29 are formed with a communication hole 61 for mutual communication therebetween. Through this communication hole 61, the first negative pressure chamber 34 of the first actuator 29 and the second pressure chamber 53 of the second actuator 30 are communicated with each other. As shown in FIGS. 2 and 4, the upper cover 51a of the second actuator 30 is formed with a second tube 51c protruding to be connected to one end of the second negative pressure pipe 12.

In this embodiment, the urging force (the mounting load) of the first spring 39 of the first actuator 29 is set to be greater than the urging force (the mounting load) of the second spring 57 of the second actuator 30. In this embodiment, for example, the urging force (the mounting load) of the first spring 39 is set at “23.6 N” and the urging force (the mounting load) of the second spring 57 is set at “11.8 N”.

In the initial mode where the VSVs 13 and 14 are both closed as mentioned above, the two-stage actuator 23 is placed in an initial state shown in FIG. 4. Specifically, no negative pressure is supplied to each of the negative pressure chamber 34 of the first actuator 29 and the negative pressure chamber 52 of the second actuator 30. Thus, the diaphragms 36 and 54 of the actuators 29 and 30 are held down by the urging forces of the corresponding springs 39 and 57, thereby disposing the operating rods 38 and 56 in respective lowermost positions. In this initial state, the link rod 42 is pushed down to a lowermost position by the first operating rod 38, thereby tilting the lever 40 downward. At that time, the first valve element 26 and the second valve element 27 are held in the initial positions shown in FIGS. 2 and 3. Specifically, the first valve element 26 is in a fully closed state of closing the bypass passage 24 as shown in FIG. 5, and the second valve element 27 is in a fully opened state of opening the main passage 25 as shown in FIG. 6. In this initial state, all the EGR gas flowing in the EGR passage 5 is allowed to flow in the EGR cooler 7.

In the first operating mode where the VSVs 13 and 14 are opened and closed, the two-stage actuator 23 is placed in a first operating state shown in FIG. 7. Specifically, negative pressure is supplied to only the first negative pressure chamber 34 of the first actuator 29. The first diaphragm 36 of the first actuator 29 is displaced or deformed upward against the urging force of the first spring 39, thereby moving the first operating rod 38 upward. At that time, the movement of the first operating rod 38 is restricted when its upper end abuts on the lower end of the second operating rod 56. In this first operating state, the link rod 42 is moved upward together with the first operating rod 38, thus turning the lever 40 by an angle corresponding to the movement of the rod 42. Accordingly, the first and second valve elements 26 and 27 are respectively held in a half-open position as shown in FIGS. 8 and 9. Concretely, the first valve element 26 is in a half opened state of opening half the bypass passage 24 as shown in FIG. 8 and the second valve element 27 is in a half opened state of opening half the main passage 25 as shown in FIG. 29. In this first operating state, all the EGR gas flowing in the EGR passage 5 is allowed to flow in both the EGR cooler 7 and the bypass passage 24.

On the other hand, in the second mode, the VSVs 13 and 14 are both opened, placing the two-stage actuator 23 in a second state shown in FIG. 10. Specifically, negative pressure is supplied to each of the negative pressure chamber 34 of the first actuator 29 and the negative pressure chamber 35 of the second actuator 30, each of the diaphragms 36 and 54 of the actuators 29 and 30 are displaced or deformed upward respectively against the urging forces of the springs 39 and 57, causing the operating rods 38 and 56 to move upward together to be disposed in respective uppermost positions. In this second operating state, the link rod 42 is moved upward together with the first operating rod 38, further turning the lever 40 upward by an angle corresponding to the further movement of the rod 42. Accordingly, the first and second valve elements 26 and 27 are held in respective operating positions shown in FIGS. 11 and 12. Concretely, the first valve element 26 is in a fully opened state of fully opening the bypass passage 24 as shown in FIG. 11 and the second valve element 27 is in a fully closed state of fully closing the main passage 25 as shown in FIG. 12. In this second operating state, all the EGR gas flowing in the EGR passage 5 is allowed to flow in the bypass passage 24.

According to the bypass valve 9 in this embodiment mentioned above, the control of opening and closing of the first and second VSVs 13 and 14 enables selective supply of negative pressure to the negative pressure chambers 34 of the first actuator 29 and the negative pressure chamber 52 of the second actuator 30 constituting the two-state actuator 23, thereby switching opening and closing of the first and second valve elements 26 and 27. For instance, at the time when a vehicle starts during a cold period, the ECU 15 opens the first and second VSVs 13 and 14 respectively to supply negative pressure to the negative pressure chamber 34 of the first actuator 29 and the negative pressure chamber 52 of the second actuator 30 through the tubes 33c and 51c respectively, thereby placing the two-stage actuator 23 in the second operating state. Accordingly, all the EGR gas flowing in the EGR passage 5 is allowed to flow in the bypass passage 24 without passing through the EGR cooler 7. At start-up of the engine 1 during a cold period, therefore, it is possible to prevent excessive cooling of the EGR gas and hence prevent lowering in combustion efficiency in each cylinder and deterioration of components of exhaust gas. As the engine 1 is warmed up, thereafter, the ECU 15 closes only the second VSV 14 to stop supply of negative pressure to the second negative pressure chamber 52 of the second actuator 30, and the negative pressure is supplied to only the first negative pressure chamber 34 of the first actuator 29. Thus, the two-stage actuator 23 is placed in the first operating state. Accordingly part of the EGR gas flowing in the EGR passage 5 will flow in the EGR cooler 7 and remaining part of the EGR gas will flow in the bypass passage 24. This makes it possible to cool the EGR gas to a certain degree as the engine 1 is warmed up. After completion of warm-up of the engine 1, the ECU 15 closes both the first and second VSVs 13 and 14 to stop supply of negative pressure to both the negative pressure chamber 34 of the first actuator 29 and the negative pressure chamber 52 of the second actuator 30. Thus, the two-stage actuator 23 is placed in the initial state. Accordingly, all the EGR gas flowing in the EGR passage 5 will flow in the EGR cooler 7 and be cooled therein. After completion of warm-up of the engine 1, therefore, the EGR gas can be further cooled.

In short, according to the bypass valve 9 of this embodiment, the first operating rod 38 is moved in stages, thereby stepwise rotating the valve shaft 28 through the lever 40, causing each of the valve elements 26 and 27 to operate in stages to switch the passages for the EGR gas in stages. That is, the opening/closing position of each of the valve elements 26 and 27 can be selected from three patterns (initial position, half-open position, and operating position). If a conventional single-stage actuator is used instead of the two-stage actuator 23, each valve element 26 and 27 can only be switched between two positions, i.e., the initial position and the operating position. On the other hand, the use of the two-stage actuator 23 as in this embodiment enables switching of each valve element 26 and 27 to the half-open position besides the initial position and the operating position. This makes it possible to change, in three stages, the flow rate of EGR gas allowed to flow in the EGR cooler 7 and hence change the cooling degree of EGR gas by the EGR cooler 7 in three levels. In this embodiment, accordingly, a high degree of freedom of controlling the EGR gas temperature can be achieved. Furthermore, the bypass valve 9 arranged to open and close the valve elements 26 and 27 by use of the diaphragm actuators 29 and 30 in this embodiment can be simple in structure and low in cost as compared with a bypass valve arranged to steplessly adjust the opening degree of the valve element by use of an electric motor such as a step motor.

According to the two-stage actuator 23 in this embodiment, the first bush is provided for the first operating rod 38 and the second bush 58 is provided for the second operating rod 56. Thus, movements of the operating rods 38 and 56 are guided by the bushes 44 and 58 respectively. Even when the actuators 29 and 30 are vibrated in association with running of the vehicle, the operating rods 38 and 56 are held against vibration by the bushes 44 and 58 respectively, thus restraining vibration of the diaphragms 36 and 54. This makes it possible to enhance vibration resistance of each of the diaphragms 36 and 54 and therefore improve vibration resistance of the two-stage actuator 23.

According to the two-stage actuator 23 in this embodiment, furthermore, the urging force (the mounting load) of the first spring 39 of the first actuator 29 is set to be greater than the urging force (the mounting load) of the second spring 57 of the second actuator 30, so that the first operating rod 38 can be smoothly moved in stages. To be concrete, when negative pressure is supplied to the second negative pressure chamber 52 of the second actuator 30 in order to further move the first operating rod 38 from the state where negative pressure is supplied to only the first pressure chamber 34 of the first actuator 29, the second diaphragm 54 can be smoothly moved upward by the relation in urging force (mounting load) between the first spring 39 and the second spring 57. Thus, the first rod 38 can be smoothly moved and consequently the opening degree of each valve element 26 and 27 can be smoothly adjusted in three stages.

According to the EGR cooler bypass valve in this embodiment, furthermore, the first operating rod 38 is moved in stages, thereby opening and closing the first and second valve elements 26 and 27 in stages to switch between the bypass passage 24 and the main passage 25 in stages. Thus, the opening/closing of the two valve elements 26 and 27 enables switching of the passages for EGR gas.

### Second Embodiment

A second embodiment of a passage switching valve of the invention will be described below referring to accompanying drawings. In each of the following embodiments, similar or identical parts to those in the first embodiment are given the same reference signs without repeating the details thereof. The following embodiments are explained with a focus on differences from the first embodiment.

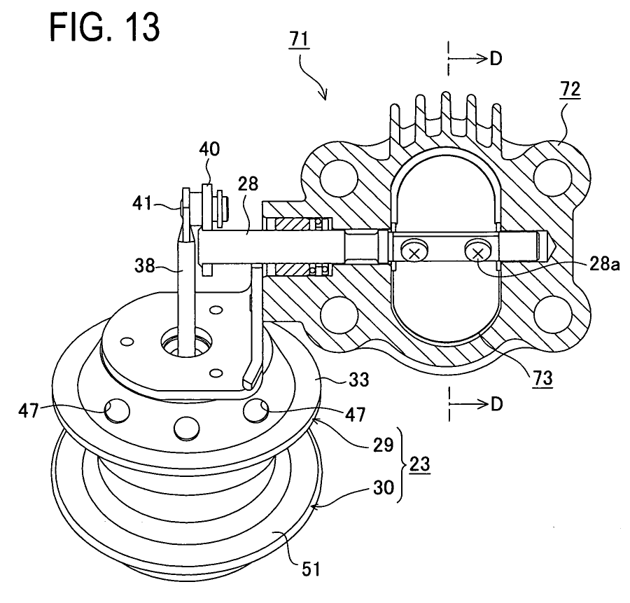

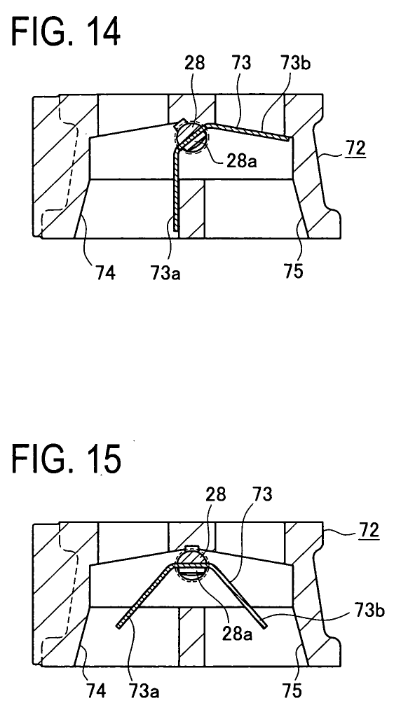

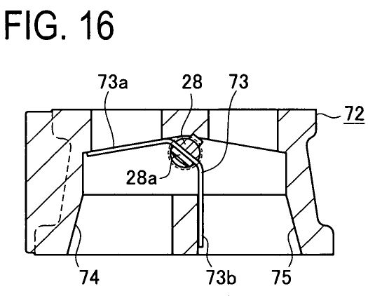

FIG. 13 is a partly sectional bottom view of a bypass valve 71 in the second embodiment. FIG. 14 is a sectional view of a passage block taken along a line D-D in FIG. 13. FIG. 15 is a sectional view of the passage block in a state changed from a state shown in FIG. 14. FIG. 16 is a sectional view of the passage block in a state changed from the state shown in FIG. 15. The bypass valve 71 in this embodiment differs from the first embodiment in configurations of a passage block 72 and a valve element 73. In this passage block 72, the valve element 73 is fixed onto the valve shaft 28 and a main passage 74 and a bypass passage 75 are formed to be opened and closed by the valve element 73. Specifically, the passage block 72 includes the main passage 74 and the bypass valve 75, which are provided adjacently. On the valve shaft 28, the single valve element 73 is fixed with screws 28 in order to open and close the main passage 74 and the bypass passage 75. As shown in FIGS. 14 to 16, the valve element 73 is designed to be bent at the valve shaft 28 into nearly V-shape in section to provide half segments 73a and 73b for opening and closing the corresponding passages 74 and 75.

In a state shown in FIG. 14, the valve element 73 is placed in an initial position for fully opening the main passage 74 and fully closing the bypass passage 75. In this state, part of the valve element 73 abuts on an inner wall of the passage block 72 to keep the valve element 73 in the initial position. When the valve shaft 28 is rotated by a predetermined angle from the initial position, the valve element 73 is disposed in a half-open position for partly opening the main passage 74 and the bypass passage 75 as shown in FIG. 15. When the valve shaft 28 is further rotated from the half-open position, the valve element 73 is moved to a final position for fully closing the main passage 74 and fully opening the bypass passage 75. In this state, part of the valve element 73 abuts on the inner wall of the passage block 72 to keep the valve element 73 in the final position. In this embodiment, other configurations except for the passage block 72 are the same as those in the first embodiment.

According to the EGR cooler bypass valve in this embodiment, when the first operating rod 38 is moved in stages, the single valve element 73 is stepwise opened and closed to switch between the main passage 74 and the bypass passage 75 in stages. Accordingly, opening and closing of the single valve element 73 enables stepwise switching of the passages for EGR gas.

In this embodiment, consequently, the passage block 72 has only to be provided with a single valve element 73 and two passages 74 and 75 corresponding thereto. Thus, the passage block 72 can be reduced in size. Other operations and advantages are the same as those in the first embodiment.

### Third Embodiment

A third embodiment of a passage switching valve of the invention will be described referring to the accompanying drawings.

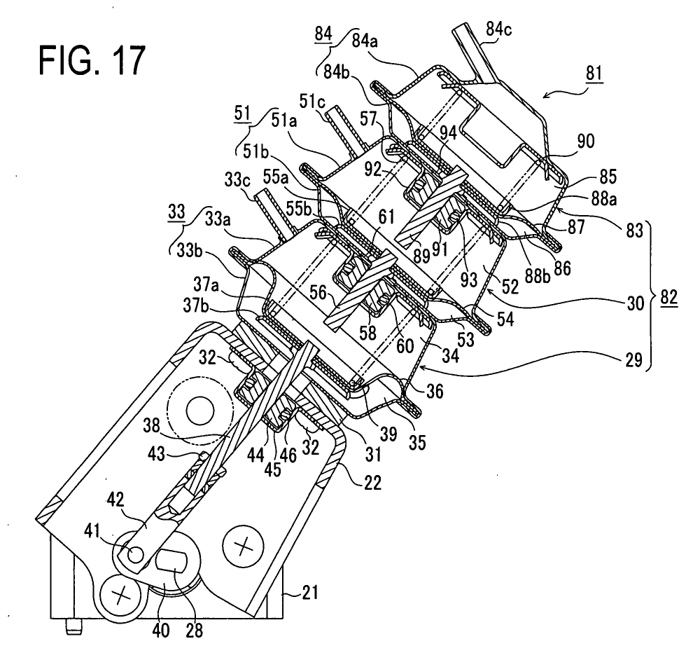

FIG. 17 is a sectional view of a three-stage actuator 82 of a bypass valve 81. This bypass valve 81 differs from that in the first embodiment in the use of a three-stage actuator 82 instead of the two-stage actuator 23. Specifically, this three-stage actuator 82 includes a third actuator 83 placed on top of the second actuator 30, besides the first actuator 29 and the second actuator 30 placed up one on top of the other. The structures of the first and second actuators 29 and 30 are basically identical to those in the first embodiment. The third actuator 83 includes a third case 84 having an upper cover 84a and a lower cover 84b, a third diaphragm 87 for dividing the internal space of the third case 84 into an upper, third negative pressure chamber 85 and a lower, third pressure chamber 86. The third actuator 83 further includes shells 88a and 88b between which the third diaphragm 87 is sandwiched, a third operating rod 89 whose upper end is fixed to the third diaphragm 87 and both shells 88a and 88b, and a third spring 90 interposed between the third case 84 (the upper cover 84a) and the third diaphragm 87 in the third negative pressure chamber 85. The third operating rod 89 extends through the lower cover 84b of the third case 84 and the upper cover 51a of the second case 51 so that a lower end of the rod 89 is located in the second negative pressure chamber 52 of the second actuator 30. The upper end of the second operating rod 56 is abuttable on the lower end of the third operating rod 89. This third operating rod 89 is slidably supported by a third bush 91 provided on an inner wall of the top of the upper cover 51a of the second actuator 30. This bush 91 is fixed by a retainer 92 to the upper cover 51a. An O-ring 93 is interposed between the third bush 91 and the retainer 92. The third bush 91 serves to restrain vibration of the third operating rod 89 in a radial direction. The lower cover 84b of the third actuator 83 and the upper cover 51a of the second actuator 30 are formed with a communication hole 94 for mutual communication therebetween. Through this communication hole 94, the second negative pressure chamber 52 of the second actuator 30 and the third pressure chamber 86 of the third actuator 83 are communicated with each other. The upper cover 84a of the third actuator 83 is formed with a third tube 84c protruding to be connected to one end of a third negative pressure pipe (not shown).

In this embodiment, the urging force (the mounting load) of the first spring 39 of the first actuator 29 is set to be greater than the urging force (the mounting load) of the second spring 57 of the second actuator 30. Furthermore, the urging force (the mounting load) of the second spring 57 of the second actuator 30 is set to be greater than the urging force (the mounting load) of the third spring 90 of the third actuator 83.

According to the bypass valve 82 in this embodiment, as shown in FIG. 17, in the initial state where no negative pressure is supplied to each of the negative pressure chambers 34, 52, and 85 of the first to third actuators 29, 30, and 83, each of the valve elements 26 and 27 is placed in a first position (shown in FIGS. 5 and 6) which is the initial position. In this initial state, all the EGR gas flowing in the EGR passage 5 is allowed to flow in the EGR cooler 7.

From such initial state, when negative pressure is started to be supplied to the first negative pressure chamber 34 of the first actuator 29 through the first tube 33c, the first diaphragm 36 is moved together with the first operating rod 38 toward the first negative pressure chamber 34 against the urging force of the first spring 39. Thus, each valve element 26 and 27 is switched from the first position to the second position, thereby changing the passage for part of the EGR gas. At that time, the movement of the first operating rod 38 is restricted when its upper end abuts on the lower end of the second operating rod 56. In this state, part of the EGR gas flowing in the EGR passage 5 will flow in the bypass passage 8 and remaining part of the EGR gas will flow in the EGR cooler 7.

Successively, negative pressure is also supplied to the second negative pressure chamber 52 of the second actuator 30 through the second tube 51c in addition to the first actuator 29. This causes the second diaphragm 54 to move together with the second operating rod 56 toward the second negative pressure chamber 52 against the urging force of the second spring 57. Accordingly, the first operating rod 38 is further moved to switch each valve element 26 and 27 from the second position to a third position. At that time, the movement of the first operating rod 38 is restricted when the upper end of the second operating rod 56 abuts on the lower end of the third operating rod 89. Accordingly, in the EGR passage 5, the amount of EGR gas allowed to flow in the bypass passage 8 is increased, and remaining part of EGR gas will flow in the EGR cooler 7.

Subsequently, negative pressure is also supplied to the third negative pressure chamber 85 of the third actuator 83 through the third tube 84c as well as the first and second actuators 29 and 30. Thus, the third diaphragm 87 is moved together with the third operating rod 89 toward the third negative pressure chamber 85 against the urging force of the third spring 90. Accordingly, the first operating rod 38 is further moved to switch each valve element 26 and 27 completely to a fourth position (shown in FIGS. 11 and 12). Thus, all the EGR gas flowing in the EGR passage 5 will flow in the bypass passage 8.

According to the bypass valve 81 in this embodiment, therefore, stepwise movement of the first operating rod 38 causes the valve shaft 28 to turn in stages through the lever 40, thereby operating each valve element 26 and 27 in stages to change the passage for EGR gas in stages. In this embodiment, in short, the opening/closing position of each valve element 26 and 27 can be selected from four patterns (initial position (first position), second position, third position, and fourth position). If a conventional single-stage actuator is used instead of the three-stage actuator 82, each valve element 26 and 27 can only be switched between two positions, i.e., the initial position and the operating position. On the other hand, the use of the three-stage actuator 82 as in this embodiment enables switching of each valve element 26 and 27 to the intermediate, second and third positions besides the initial position and the operating position (fourth position). This makes it possible to change, in four stages, the flow rate of EGR gas allowed to flow in the EGR cooler 7 and hence change the cooling degree of EGR gas by the EGR cooler 7 in four levels.

According to the three-stage actuator 82 in this embodiment, the first bush 44 is provided for the first operating rod 38, the second bush 58 is placed for the second operating rod 56, and the third bush 91 is provided for the third operating rod 89. The movement of each of the operating rods 38, 56, and 89 is guided by each corresponding bush 44, 58, and 91. Even when the actuators 29, 30, and 83 are vibrated in association with running of the vehicle, the operating rods 38, 56, and 89 are held against vibration by the bushes 44, 58, and 91 respectively to thereby prevent vibration of the diaphragms 36, 54, and 87. This makes it possible to enhance vibration resistance of each of the diaphragms 36, 54, and 87.

According to the three-stage actuator 81 in this embodiment, furthermore, the urging force (the mounting load) of the first spring 39 of the first actuator 29 is set to be greater than the urging force (the mounting load) of the second spring 57 of the second actuator 30, and the urging force (the mounting load) of the second spring 57 is set to be greater than the urging force (the mounting load) of the third spring 90 of the third actuator 83, so that the first operating rod 38 can be smoothly moved in stages. To be concrete, when negative pressure is supplied to the second negative pressure chamber 52 of the second actuator 30 in order to further move the first operating rod 38 from the state where negative pressure is supplied to only the first pressure chamber 34 of the first actuator 29, the second diaphragm 54 can be smoothly moved upward by a difference in urging force (mounting load) between the first spring 39 and the second spring 57. Furthermore, when negative pressure is also supplied to the third negative pressure chamber 85 of the third actuator 83 in order to further move the first operating rod 38 from the state where negative pressure is supplied to the first and second negative pressure chambers 34 and 52 of the first and second actuators 29 and 30, the third diaphragm 87 can be smoothly moved upward by differences in urging force (mounting load) among the first spring 39, the second spring 57, and the third spring 90. Thus, the first rod 38 can be smoothly moved and consequently the opening degree of each valve element 26 and 27 can be smoothly adjusted in four stages.

The present invention is not limited to the above embodiment(s) and may be embodied in other specific forms without departing from the essential characteristics thereof.

What is claimed is:

1. A passage switching valve comprising:
a valve element to be operated to switch between passages; and
a diaphragm actuator for operating the valve element,
wherein the actuator includes a first actuator and a second actuator placed one on top of the first actuator,
the first actuator including: a first case; a first diaphragm dividing internal space of the first case to form a first negative pressure chamber; a first operating rod fixed at an upper portion to the first diaphragm; and a first spring interposed between the first case and the first diaphragm in the first negative pressure chamber,
the first operating rod being placed to extend downward from the first case and be connected to the valve element to operate the valve element,
the second actuator including: a second case; a second diaphragm dividing internal space of the second case to form an upper second negative pressure chamber and a lower second pressure chamber; a second operating rod fixed at an upper portion to the second diaphragm; and a second spring interposed between the second case and the second diaphragm in the second negative pressure chamber,
the second operating rod being placed to extend through the second case and the first case into the first negative pressure chamber so that an upper end of the first operating rod is abuttable on a lower end of the second operating rod, and
the second pressure chamber and the first negative pressure chamber being communicated with each other.

2. The passage switching valve according to claim 1, further comprising:
a third actuator placed on top of the second actuator, the third actuator including: a third case; a third diaphragm dividing internal space of the third case into an upper third negative pressure chamber and a lower third pressure chamber; a third operating rod fixed at an upper portion to the third diaphragm; and a third spring interposed between the third case and the third diaphragm in the third negative pressure chamber,
the third rod being placed to extend through the third case and the second case into the second negative pressure chamber so that an upper end of the second operating rod is abuttable on a lower end of the third operating rod, and
the third pressure chamber and the second negative pressure chamber being communicated with each other.

3. The passage switching valve according to claim 1, further comprising a first vibration restraining member and a second vibration restraining member for restraining vibration of the first operating rod and the second operating rod in respective radial directions.

4. The passage switching valve according to claim 2, further comprising a first vibration restraining member, a second vibration restraining member, and a third vibration restraining member for restraining vibration of the first operating rod, the second operating rod, and the third operating rod in respective radial directions.

5. The passage switching valve according to claim 1, wherein an urging force of the first spring is set to be greater than an urging force of the second spring.

6. The passage switching valve according to claim 3, wherein an urging force of the first spring is set to be greater than an urging force of the second spring.

7. The passage switching valve according to claim 2, wherein an urging force of the first spring is set to be greater than an urging force of the second spring, and the urging force of the second spring is set to be greater than an urging force of the third spring.

8. The passage switching valve according to claim 4, wherein an urging force of the first spring is set to be greater than an urging force of the second spring, and the urging force of the second spring is set to be greater than an urging force of the third spring.

9. The passage switching valve according to claim 1, wherein
the passages include a first passage and a second passage,
the valve element includes a first valve element for opening and closing the first passage and a second valve element for opening and closing the second passage, and
the first operating rod is axially moved to cause the first valve element and the second valve element to open and close to switch the passage for a fluid between the first passage and the second passage.

10. The passage switching valve according to claim 2, wherein
the passages include a first passage and a second passage,
the valve element includes a first valve element for opening and closing the first passage and a second valve element for opening and closing the second passage, and
the first operating rod is axially moved to cause the first valve element and the second valve element to open and close to switch the passage for a fluid between the first passage and the second passage.

11. The passage switching valve according to claim 3, wherein
the passages include a first passage and a second passage,
the valve element includes a first valve element for opening and closing the first passage and a second valve element for opening and closing the second passage, and
the first operating rod is axially moved to cause the first valve element and the second valve element to open and close to switch the passage for a fluid between the first passage and the second passage.

12. The passage switching valve according to claim 4, wherein
the passages include a first passage and a second passage,
the valve element includes a first valve element for opening and closing the first passage and a second valve element for opening and closing the second passage, and
the first operating rod is axially moved to cause the first valve element and the second valve element to open and close to switch the passage for a fluid between the first passage and the second passage.

13. The passage switching valve according to claim 5, wherein
the passages include a first passage and a second passage,
the valve element includes a first valve element for opening and closing the first passage and a second valve element for opening and closing the second passage, and
the first operating rod is axially moved to cause the first valve element and the second valve element to open and close to switch the passage for a fluid between the first passage and the second passage.

14. The passage switching valve according to claim 6, wherein
the passages include a first passage and a second passage,
the valve element includes a first valve element for opening and closing the first passage and a second valve element for opening and closing the second passage, and
the first operating rod is axially moved to cause the first valve element and the second valve element to open and close to switch the passage for a fluid between the first passage and the second passage.

15. The passage switching valve according to claim 7, wherein
the passages include a first passage and a second passage,
the valve element includes a first valve element for opening and closing the first passage and a second valve element for opening and closing the second passage, and
the first operating rod is axially moved to cause the first valve element and the second valve element to open and close to switch the passage for a fluid between the first passage and the second passage.

16. The passage switching valve according to claim 1, wherein
the passages include a first passage and a second passage,
the valve element is a single valve element for opening and closing the first passage and the second passage, and
the first operating rod is axially moved to open and close the valve element to switch the passage for a fluid between the first passage and the second passage.

17. The passage switching valve according to claim 2, wherein
the passages include a first passage and a second passage,
the valve element is a single valve element for opening and closing the first passage and the second passage, and
the first operating rod is axially moved to open and close the valve element to switch the passage for a fluid between the first passage and the second passage.

18. The passage switching valve according to claim 3, wherein
the passages include a first passage and a second passage,
the valve element is a single valve element for opening and closing the first passage and the second passage, and
the first operating rod is axially moved to open and close the valve element to switch the passage for a fluid between the first passage and the second passage.

19. The passage switching valve according to claim 4, wherein
the passages include a first passage and a second passage,
the valve element is a single valve element for opening and closing the first passage and the second passage, and
the first operating rod is axially moved to open and close the valve element to switch the passage for a fluid between the first passage and the second passage.

20. The passage switching valve according to claim 5, wherein
the passages include a first passage and a second passage,
the valve element is a single valve element for opening and closing the first passage and the second passage, and
the first operating rod is axially moved to open and close the valve element to switch the passage for a fluid between the first passage and the second passage.

21. The passage switching valve according to claim 6, wherein
the passages include a first passage and a second passage,
the valve element is a single valve element for opening and closing the first passage and the second passage, and
the first operating rod is axially moved to open and close the valve element to switch the passage for a fluid between the first passage and the second passage.

22. The passage switching valve according to claim 7, wherein
the passages include a first passage and a second passage,
the valve element is a single valve element for opening and closing the first passage and the second passage, and
the first operating rod is axially moved to open and close the valve element to switch the passage for a fluid between the first passage and the second passage.
